(19) United States
(12) Patent Application Publication
(10) Pub. No.: US 2025/0094833 A1
(43) Pub. Date: Mar. 20, 2025

(54) FINE-TUNING METHOD, DEVICE AND APPLICATION FOR CLASSIFICATION MODEL OF KNOWLEDGE REPRESENTATION DECOUPLING

(71) Applicant: ZHEJIANG UNIVERSITY, HANGZHOU, Zhejiang Province (CN)

(72) Inventors: NINGYU ZHANG, HANGZHOU, ZHEJIANG PROVINCE (CN); LEI LI; XIANG CHEN, HANGZHOU, ZHEJIANG PROVINCE (CN); HUAJUN CHEN, HANGZHOU, ZHEJIANG PROVINCE (CN)

(21) Appl. No.: 18/571,196

(22) PCT Filed: Dec. 9, 2022
(86) PCT No.: PCT/CN2022/137938

§ 371 Date: Dec. 15, 2023

(30) Foreign Application Priority Data
Aug. 10, 2022 (CN) 202210955108.0

(51) Int. Cl. G06N 5/022

(52) U.S. Cl. CPC G06N 5/022

(57) ABSTRACT

The present invention discloses fine-tuning method, device, and application classification model of knowledge representation decoupling, decoupling knowledge representation and classification model, storing them in the knowledge base, and performing matching aggregation based on retrieval during application, this limits the rote memorization of the learning model and improves its generalization ability. At the same time, KNN is used to retrieve adjacent instance phrases from the knowledge base as continuous neural examples, and neural examples are used to guide classification model training and correct classification model predictions, improving the ability of the classification model in small and zero sample scenarios, when the amount of data is sufficient, the knowledge base also has better and richer information, and the classification model performs very well in fully supervised scenarios.

### TECHNICAL FIELD

The present invention belongs to the field of natural language processing technology, and specifically relates to a fine-tuning method, device, and application for classification model of knowledge representation decoupling.

### DESCRIPTION OF RELATED ART

The pre-trained classification model has achieved exciting and significant results in the field of natural language processing by deeply learning knowledge from massive data. The pre-trained classification model is trained from large-scale corpus by designing universal pre training tasks such as Masked Language Modeling (MLM) and Next Sentence Prediction (NSP), training from large-scale corpus, when applied to downstream relationship classification, emotion classification, and other classification tasks, only a small amount of data is needed to fine tune the pre-trained classification model, which can achieve good performance.

The emergence of prompt learning reduces the difference of the pre-trained classification model between the fine-tuning stage and pre training stage, further enabling the pre-trained classification model to have the ability to learn with fewer and zero samples. Prompt learning can be divided into discrete prompt and continuous prompt, the discrete prompt convert input forms by manually constructing discrete prompt temporary, and the continuous prompt adds a series of learnable continuous embedding vectors to the input sequence, reducing prompt engineering.

However, recent studies have shown that the generalization ability of the pre-trained classification model is not satisfactory when the amount of data is extremely scarce. One potential reason is that parametric model has difficulty grasping sparse and difficult samples through memory, resulting in insufficient generalization ability. When the data presents a long tailed distribution and has small clusters of atypical instances, the pre-trained classification model tends to make predictions by rote memorization of these atypical instances rather than by learning more general pattern knowledge, this can lead to poor performance of the knowledge representation learned by the pre-trained classification model in the downstream classification task and low accuracy of classification result.

Patent document CN101127042A discloses a sentiment classification method based on classification model, while patent document CN108363753A discloses a training and sentiment classification method, device, and device for comment text sentiment classification model. Both patent applications extract the embedding direction of the text and construct sentiment classification based on the embedding vector. When the sample data is scarce in these two methods, it is difficult to achieve the accuracy of sentiment classification due to poor extracted embedding vectors.

### SUMMARY OF THE INVENTION

The object of the present invention is to provide a fine-tuning method, device, and application classification model of knowledge representation decoupling in response to the aforementioned technical problems existing in the existing technology. By decoupling the knowledge representation obtained from the classification model into a knowledge base, which serves as a similarity guide to optimize the classification model, improving the ability and accuracy of the knowledge representation of the classification model, and thereby improving the classification accuracy of downstream classification tasks.

To achieve the above object of the present invention, the embodiment provides a fine-tuning method for classification model of knowledge representation decoupling, comprising the following steps:
step 1: building a knowledge base for retrieval, wherein multiple instance phrases are stored in the form of key value pair, the key stores an embedding vector of the instance phrase, and the value stores a true value of label of the instance phrase;
step 2, constructing a classification model that comprises a pre-trained language model and a prediction and classification module;
step 3: using the pre-trained language model to extract a first embedding vector of the masked words in the input instance text, and using this first embedding vector as a first query vector, for each label class, querying multiple instance phrases closest to the first query vector from the knowledge base as a first neighboring instance phrase, using an aggregation result obtained by aggregating all the first neighboring instance phrases with the first query vector as an input data for the pre-trained language model;
step 4: using the pre-trained language model to extract a second embedding vector of the masked words in the input data, and using the prediction and classification module to classify and predict the second embedding vector to obtain a classification and prediction probability, based on the classification and prediction probability and the true value of label of the masked words, calculating a classification loss;
step 5, constructing a weight factor based on the true value of label of the masking word, and adjusting the classification loss based on the weight factor to make the classification loss more focused on misclassified instances;
step 6, optimizing parameters of the classification model by using the adjusted classification loss to obtain an classification model after parameters optimization.

To achieve the above object of the present invention, the embodiment provides a fine-tuning device for classification model of knowledge representation decoupling, comprising:
a knowledge base construction and update unit, building a knowledge base for retrieval, where multiple instance phrases are stored in the form of key value pair, the key stores an embedding vector of the instance phrase, and the value stores a true value of label of the instance phrase;
a classification model construction unit, constructing a classification model that comprises a pre-trained language model and a prediction and classification module;
a query and aggregation unit, using the pre-trained language model to extract a first embedding vector of the masked words in the input instance text, and using the first embedding vector as a first query vector, for each label class, querying multiple instance phrases closest to the first query vector from the knowledge base as a first neighboring instance phrase, using an aggregation result obtained by aggregating all the first neighboring instance phrases with the first query vector as an input data for the pre-trained language model;
a loss calculation unit, using the pre-trained language model to extract a second embedding vector of the masked words in the input data, and using the prediction and classification module to classify and predict the second embedding vector to obtain a classification and prediction probability, based on the classification and prediction probability and the true value of label of the masked words, calculating a classification loss;
a loss adjustment unit, constructing a weight factor based on the true value of label of the masking word, and adjusting the classification loss based on the weight factor to make the classification loss more focused on misclassified instances;
a parameter optimization, optimizing parameters of the classification model by using the adjusted classification loss to obtain a classification model after parameters optimization.

To achieve the above invention, the embodiment also provides a task classification method by using the classification model of knowledge representation decoupling, the task classification method applies the knowledge base constructed by the fine-tuning method and the classification model after parameters optimization, comprising the following steps:
step 1: using the classification model after parameters optimization to extract a third embedding vector of the masked words in the input instance text, and using the third embedding vector as a third query vector, for each label class, querying multiple instance phrases closest to the third query vector from the knowledge base as a third neighboring instance phrase, using an aggregation result obtained by aggregating all the third neighboring instance phrases with the third query vector as an input data for the pre-trained language model;
step 2, using the pre-trained language model after parameters optimization to extract a fourth embedding vector of masking words from the input data, for each class, querying multiple instance texts closest to the fourth query vector from the knowledge base as a fourth neighboring instance text, calculating a class correlation probability based on the similarity between the fourth query vector and the fourth neighboring instance text;
step 3, using the prediction and classification module after parameters optimization to classify and predict the fourth embedded vector to obtain a classification and prediction probability;
step 4, using a weighted result of the class correlation probability and the classification and prediction probability of each class as the total classification and prediction result.

Comparing with the prior art, the beneficial effects of the present invention at least comprise:
Decoupling knowledge representation and classification model, storing them in the knowledge base, and performing matching aggregation based on retrieval during application, this limits the rote memorization of the learning model and improves its generalization ability. At the same time, K-Nearest Neighbors Algorithm (KNN) is used to retrieve adjacent instance phrases from the knowledge base as continuous neural examples, and neural examples are used to guide classification model training and correct classification model predictions, improving the ability of the classification model in small and zero sample scenarios, when the amount of data is sufficient, the knowledge base also has better and richer information, and the classification model performs very well in fully supervised scenarios.

### BRIEF DESCRIPTION OF THE DRAWINGS

In order to provide a clearer explanation of the embodiments of the present invention or the technical solutions in the prior art, a brief introduction will be given to the accompanying drawings required in the description of the embodiments or prior art. It is evident that the accompanying drawings in the following description are only some embodiments of the present invention. For ordinary technical personnel in the art, other accompanying drawings can be obtained based on these drawings without any creative effort.

FIG. 1 is a flowchart of the fine-tuning method for classification model of knowledge representation decoupling provided by the embodiment;

FIG. 2 is the structure and training diagram of the classification model provided by the embodiment, as well as the updating diagram of the knowledge base, and the classification and prediction diagram;

FIG. 3 is a flowchart of a task classification method by using the classification model of knowledge representation decoupling provided by the embodiment.

### DETAILED DESCRIPTION OF THE INVENTION

In order to achieve the object, technical solution, and advantages of the present invention clearer, the following is a further detailed explanation of the present invention in conjunction with the accompanying drawings and embodiments. It should be understood that the specific embodiments described here are only used to explain the present invention and do not limit the scope of protection of the present invention.

Traditional prompt learning methods and fine-tuning methods cannot handle atypical samples well, resulting in weak representation ability of classification models and affecting the accuracy of classification task prediction. Existing technologies that rely on rote memorization of these atypical instances instead of learning more general pattern knowledge for prediction can lead to poor model representation ability, which is opposite to humans learning knowledge through analogy. Humans can recall relevant skills in deep memory through associative learning, thereby reinforcing each other and possessing extraordinary abilities to solve small sample and zero sample tasks. Inspired by this, the embodiment provides a fine-tuning method and device for classification model of knowledge representation decoupling, as well as a classification application of the fine-tuning classification model, constructing a knowledge base from the training instance text, memory is decoupled from the pre-trained language model, providing reference knowledge for model training and prediction, and improving the generalization ability of the model.

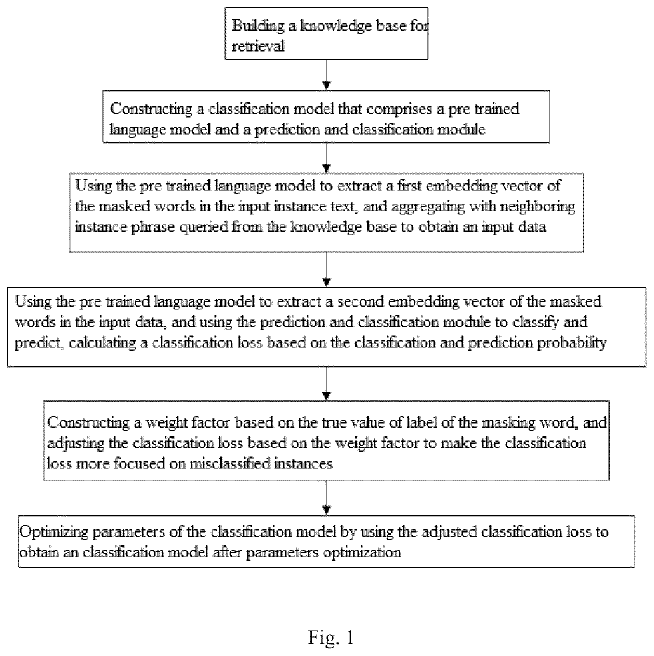

FIG. 1 is a flowchart of the fine-tuning method for classification model of knowledge representation decoupling provided by the embodiment. As shown in FIG. 1, the embodiment provides a fine-tuning method for classification model of knowledge representation decoupling, comprising the following steps:
step 1: building a knowledge base for retrieval.

In the embodiment, the knowledge base serves as an additional reference information to decouple the knowledge representation from the partial memory of the classification model, mainly used to store the knowledge representation obtained from the structure in the classification model. The knowledge representation exists in the form of instance phrases, specifically, each instance phrase is stored in the form of a key value pair, where the key stores the embedding vector of the instance phrase, and the value stores the label truth value of the instance phrase. An embedding vector of instance phrases is obtained by learning the instance text based on the prompt template through a pre-trained language model. Specifically, the mask position in the instance text is the hidden vector output in the last layer of the pre-trained language model.

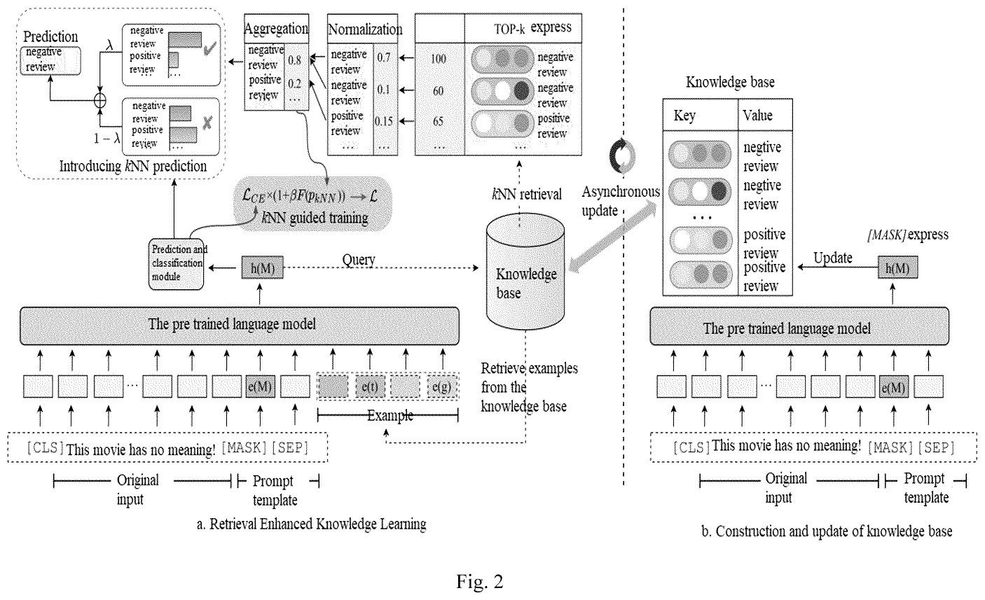

It should be noted that the knowledge base can be freely added, edited, and deleted, as shown in FIG. 2. During each training round, a first embedded vector of the masked words in the input instance text and its corresponding true value of label form a new instance phrase, which is asynchronously updated to the knowledge base.
step 2, constructing a classification model that comprises a pre-trained language model and a prediction and classification module.

As shown in FIG. 2, the classification model constructed by the embodiment comprises a pre-trained language model, which is used to represent knowledge of input instance text to extract embedding vectors at mask positions. Specifically, the input instance text needs to be serialized and transformed through a prompt template, which takes the form of [CLS] instance text [MASK] [SEP]. For example, [CLS] This movie has no meaning [MASK] [SEP], at the same time, the true value of label is mapped to a vocabulary space of the pre-trained language model through a mapping function to obtain a label vector. The prediction and classification module is used to classify and predict the input embedded vectors to output the classification and prediction probability.
step 3: using the pre-trained language model to extract a first embedding vector of the masked words in the input instance text, and aggregating with neighboring instance phrase queried from the knowledge base to obtain an input data.

In the embodiment, using the pre-trained language model to extract a first embedding vector of the masked words in the input instance text, and using this first embedding vector as a first query vector, for each label class, querying m instance phrases closest to the first query vector from the knowledge base as a first neighboring instance phrase by using KNN (K-Nearest Neighbor), the first neighboring instance phrase serves as additional example input, and the aggregation result obtained by aggregating them with the first query vector serves as input data for the pre-trained language model, where the aggregation formula is:

$$I = e ( \hat{x} ) ⊕ [ {\sum }_{i ∈ [ 1 ; m ]} ( {α}_{i}^{l} {h}_{ei}^{l} ) , e ( {v}^{l} ) ] ⊕ … ⊕ [ {\sum }_{i ∈ [ 1 ; m ]} ( {α}_{i}^{L} {h}_{ei}^{L} ) , e ( {v}^{L} ) ]$$

$${α}_{i}^{l} = \frac{{e}^{{h}_{q} \cdot {h}_{ei}^{l}}}{{\sum }_{i ∈ [ 1 ; m ]} {e}^{{h}_{q} \cdot {h}_{ei}^{l}}}$$

among them, e(\hat{x}) is an initial vector representing the input instance text that has been serialized by the prompt template, h_{q} represents the first query vector for masked words in the input instance text, hₑᵢ^{l} represents the embedding vector of the i-th first neighboring instance phrase in the l-th class label, and m is the total number of the first neighboring instance phrase, aᵢ^{l} represents softmax value of hₑᵢ^{l}, and represents the correlation with the first query vector, e(v¹) represents the true value of label of the first neighboring instance phrase, L represents the total number of labels, and I represents the aggregated result obtained, the aggregated result is used as input data, combining with instance phrases from the knowledge base, as contextual enhancement information, guiding classification model training and correcting classification model prediction, improving the ability of the classification model in small and zero sample scenarios.
Step 4: using the pre-trained language model to extract a second embedding vector of the masked words in the input data, and using the prediction and classification module to classify and predict, calculating a classification loss based on the classification and prediction probability.

In the embodiment, when constructing the calculation of classification loss, a cross entropy of the classification and prediction probability corresponding to the input data and the true value of label of the masked word is used as the classification loss L_{CE}.
Step 5, constructing a weight factor based on the true value of label of the masking word, and adjusting the classification loss based on the weight factor to make the classification loss more focused on misclassified instances.

In the embodiment, a weight of correct and incorrect classification in the classification loss is adjusted by the true value of label of masked words to make the classification model better focus on misclassified samples, the specific formula is as follows:

$$L = ( 1 + β F ( {p}_{knn} ) ) {L}_{CE}$$

among them, L_{CE} represents the classification loss, β represents an adjustment parameter, F(pₖₙₙ) represents the weight factor, which is expressed as F(pₖₙₙ)=−log(pₖₙₙ), pₖₙₙ represents the true value of label of the masked words.
Step 6, optimizing parameters of the classification model by using the adjusted classification loss to obtain a classification model after parameters optimization.

In the embodiment, the constructed classification loss is used to optimize the parameters of the classification model, and during each training round, the first embedding vector of the input instance text is used to construct the instance phrases, which are updated to the knowledge base.

The fine-tuning method of the classification model of knowledge representation decoupling mentioned above has improved the ability of the fine-tuning classification model in scenarios with few and zero samples. When the amount of data is sufficient, the knowledge base also has better and richer information, and the classification model performs very well in fully supervised scenarios.

Based on the same invention concept, the embodiment provides a fine-tuning device for classification model of knowledge representation decoupling, comprising:
a knowledge base construction and update unit, building a knowledge base for retrieval, wherein multiple instance phrases are stored in the form of key value pair, the key stores an embedding vector of the instance phrase, and the value stores a true value of label of the instance phrase;
a classification model construction unit, constructing a classification model that comprises a pre-trained language model and a prediction and classification module;
a query and aggregation unit, using the pre-trained language model to extract a first embedding vector of the masked words in the input instance text, and using this first embedding vector as a first query vector, for each label class, querying multiple instance phrases closest to the first query vector from the knowledge base as a first neighboring instance phrase, using an aggregation result obtained by aggregating all the first neighboring instance phrases with the first query vector as an input data for the pre-trained language model;
a loss calculation unit, using the pre-trained language model to extract a second embedding vector of the masked words in the input data, and using the prediction and classification module to classify and predict the second embedding vector to obtain a classification and prediction probability, based on the classification and prediction probability and the true value of label of the masked words, calculating a classification loss;
a loss adjustment unit, constructing a weight factor based on the true value of label of the masking word, and adjusting the classification loss based on the weight factor to make the classification loss more focused on misclassified instances;
a parameter optimization, optimizing parameters of the classification model by using the adjusted classification loss to obtain a classification model after parameters optimization.

It should be noted that, when the fine-tuning device for classification model of knowledge representation decoupling is used to fine tune the classification model, it should be illustrated by the division of each functional unit mentioned above, the above functions can be allocated to different functional units according to needs, that is, they can be divided into different functional units within the internal structure of the terminal or server to complete all or part of the functions described above. In addition, the fine-tuning device for classification model of knowledge representation decoupling provided by the above embodiments and the fine-tuning method for classification model of knowledge representation decoupling belong to the same concept, the specific implementation process is detailed in the embodiment of the fine-tuning method for classification model of knowledge representation decoupling, and will not be repeated here.

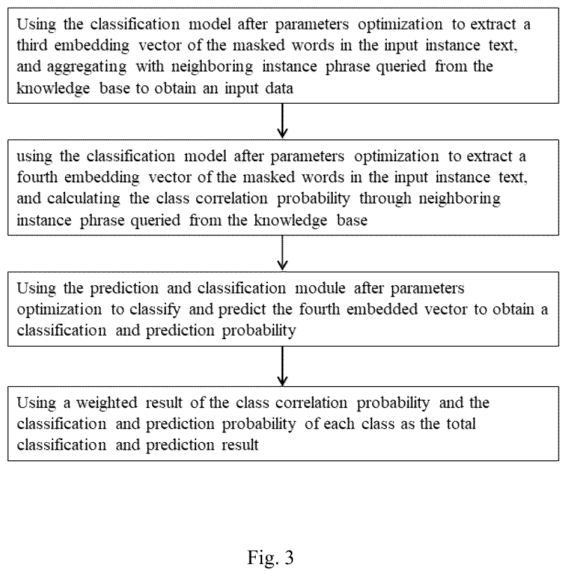

Based on the same invention concept, the embodiment also provides a task classification 1 method by using the classification model of knowledge representation decoupling, the task classification method applies the knowledge base constructed by the fine-tuning method and the classification model after parameters optimization, as shown in FIG. 3, comprising the following steps:

Step 1, using the classification model after parameters optimization to extract a third embedding vector of the masked words in the input instance text, and aggregating with neighboring instance phrase queried from the knowledge base to obtain an input data.

In the embodiment, using the classification model after parameters optimization to extract the third embedding vector of the masked words in the input instance text, and using the third embedding vector as a third query vector, for each label class, querying multiple instance phrases closest to the third query vector from the knowledge base as a third neighboring instance phrase, using an aggregation result obtained by aggregating all the third neighboring instance phrases with the third query vector as the input data for the pre-trained language model.

Using the non-parametric method KNN to retrieve instance phrases adjacent to the input instance text from the knowledge base, the KNN retrieval results are treated as indicative information of easy and difficult instances, making the classification model pay more attention to difficult samples during training.
Step 2, using the classification model after parameters optimization to extract a fourth embedding vector of the masked words in the input instance text, and calculating the class correlation probability through neighboring instance phrase queried from the knowledge base.

In the embodiment, using the pre-trained language model after parameters optimization to extract a fourth embedding vector of masking words from the input data, for each class, querying multiple instance texts closest to the fourth query vector from the knowledge base as a fourth neighboring instance text, calculating the class correlation probability based on the similarity between the fourth query vector and the fourth neighboring instance text;

Specifically, the class correlation probability is calculated based on the similarity between the fourth query vector and the fourth neighboring instance text by using the following formula:

$${P}_{KNN} ( {y}_{i} \vert {q}_{t} ) = {\sum }_{( ci , yi ) ∈ N} exp ( d ( {h}_{{q}_{t}} , {h}_{ci} ) )$$

among them, P_{KNN}(yi|qₜ) represents the class correlation probability of the i-th classification class of the input instance text qₜ, d(h_{q}_{ₜ}, h_{ci}) represents an inner product distance between the fourth query vector h_{q}_{ₜ} of the input instance text qₜ and the embedding vector h_{ci} of instance phrase ci belonging to the i-th classification category yi, which is taken as an inner product similarity, N represents the knowledge base.

KNN is a non-parametric method that can easily make predictions on input instance text without requiring any classification layer. Therefore, the classification result (class correlation probability) of KNN can be intuitively used as a prior knowledge to guide the pre-trained classification model, making it more focused on difficult samples (or atypical samples).
Step 3, using the prediction and classification module after parameters optimization to classify and predict the fourth embedded vector to obtain a classification and prediction probability.
Step 4, using a weighted result of the class correlation probability and the classification and prediction probability of each class as the total classification and prediction result.

Traditional pre-trained language models only rely on the parameterized memory ability of the model during prediction. By introducing the non-parameterized method KNN, the model can make decisions by retrieving the nearest neighbor sample during prediction, similar to the “open book exam”. the class correlation probability P_{KNN}(yi|qₜ) is obtained through KNN retrieval, the classification and prediction probability P(yi|qₜ) is output by the classification model, the total classification and prediction result is obtained by weighting and summing the two probability distributions, which is expressed as:

$$P = γ {P}_{KNN} ( yi \vert {q}_{t} ) + ( 1 - γ ) P ( yi \vert {q}_{t} )$$

among them, γ represents a weight parameter.

The class correlation probability P_{KNN}(yi|qₜ) is obtained through KNN retrieval can be further used in the inference process of the classification model to correct errors generated during inference.

The task classification method provided by the embodiment by using the classification model of knowledge representation decoupling can be used for relationship classification tasks. When used for relationship classification tasks, the true value of the label of instance phrases stored in the knowledge base is the relationship type, comprising friend relationship, kinship relationship, colleague relationship, and classmate relationship. During relationship classification, the class correlation probability of each relationship type is calculated through steps 1 and 2 based on the input instance text, the classification and prediction probability is calculated according to step 3, and the total classification and prediction result corresponding to each relationship type is calculated according to step 4, the maximum total classification and prediction result obtained through filtering is used as the final relationship classification result corresponding to the input instance text.

The task classification method provided by embodiment by using the classification model of knowledge representation decoupling can be used for emotion classification tasks. When used for emotion classification tasks, the true value of the label of instance phrases stored in the knowledge base are emotion types, comprising positive and negative emotions. When performing emotion classification, the class correlation probability of each emotion type is calculated through steps 1 and 2 based on the input instance text, the classification and prediction probability is calculated according to step 3, and the total classification and prediction result corresponding to the emotion type is calculated according to step 4, the maximum total classification and prediction result obtained through filtering is used as the final emotion classification result corresponding to the input instance text.

In the emotion classification task, Roberta-large is used as the pre-trained language model. In order to improve the retrieval speed, the open-source library FAISS is used for KNN retrieval. When the input instance text is “This movie has no meaning!”, the process of emotion classification is:
(1) Building a prompt template to convert the input instance text, and after the prompt template conversion, the input becomes “[CLS] This movie has no meaning! [MASK] [SEP]”.
(2) Using the pre-trained language model to obtain the input instance text [MASK] position in the embedding vector, retrieving neural examples from the knowledge base, concatenating and aggregating the input instance text at the [MASK] position in the embedding vector, and then inputting it into the pre-trained language model.
(3) Retrieving the nearest neighboring instance phrase from the knowledge base by using the hidden state of the input instance text [MASK] position in the last layer of the language model as a query vector, and calculating the class correlation probability P_{KNN}(yi|qₜ) based on the instance phrase, where the probability of label as “negative review” is 0.8, and the probability of label as “positive review” is 0.2;
(4) Using the prediction and classification module to obtain the classification and prediction probability P(yi|qₜ) of the query vector, where the probability of label as “negative review” is 0.4, and the probability of label as “positive review” is 0.6;
(5) Weighting and summing the two probabilities P_{KNN}(yi|qₜ) and P(yi|qₜ) to obtain the total classification prediction result, with the weight parameters γ is 0.5, so the total classification and prediction probability of label as “negative review” is 0.6, and the total classification and prediction probability of label as “positive review” is 0.4.

The specific implementation methods mentioned above provide a detailed explanation of the technical solution and beneficial effects of the present invention. It should be understood that the above are only the optimal embodiments of the present invention and are not intended to limit the present invention. Any modifications, supplements, and equivalent replacements made within the scope of the principles of the present invention should be included in the scope of protection of the present invention.

1. A fine-tuning method for classification model of knowledge representation decoupling, comprising the following steps:
step 1: building a knowledge base for retrieval, where multiple instance phrases are stored in the form of key value pair, the key stores an embedding vector of the instance phrase, and the value stores a true value of label of the instance phrase;
step 2, constructing a classification model that comprises a pre-trained language model and a prediction and classification module;
step 3: using the pre-trained language model to extract a first embedding vector of the masked words in the input instance text, and using this first embedding vector as a first query vector, for each label class, querying multiple instance phrases closest to the first query vector from the knowledge base as a first neighboring instance phrase, using an aggregation result obtained by aggregating all the first neighboring instance phrases with the first query vector as an input data for the pre-trained language model;
step 4: using the pre-trained language model to extract a second embedding vector of the masked words in the input data, and using the prediction and classification module to classify and predict the second embedding vector to obtain a classification and prediction probability, based on the classification and prediction probability and the true value of label of the masked words, calculating a classification loss;
step 5, constructing a weight factor based on the true value of label of the masking word, and adjusting the classification loss based on the weight factor to make the classification loss more focused on misclassified instances;
step 6, optimizing parameters of the classification model by using the adjusted classification loss to obtain a classification model after parameters optimization.

2. The fine-tuning method for classification model of knowledge representation decoupling according to claim 1, wherein, using KNN to retrieve multiple instance phrases closest to the first query vector from the knowledge base as the first neighboring instance phrase, and aggregating all the first neighboring instance phrases and the first query vector through the following aggregation method:
$$I = e ( \hat{x} ) ⊕ [ {\sum }_{i ∈ [ 1 ; m ]} ( {α}_{i}^{l} {h}_{ei}^{l} ) , e ( {v}^{l} ) ] ⊕ … ⊕ [ {\sum }_{i ∈ [ 1 ; m ]} ( {α}_{i}^{L} {h}_{ei}^{L} ) , e ( {v}^{L} ) ]$$
$${α}_{i}^{l} = \frac{{e}^{{h}_{q} \cdot {h}_{ei}^{l}}}{{\sum }_{i ∈ [ 1 ; m ]} {e}^{{h}_{q} \cdot {h}_{ei}^{l}}}$$
wherein, I represents the aggregation result obtained by aggregating, e(\hat{x}) is an initial vector representing the input instance text that has been serialized by the prompt template, h_{q} represents the first query vector for masked words in the input instance text, hₑᵢ^{l} represents the embedding vector of the i-th first neighboring instance phrase in the l-th class label, and m is the total number of the first neighboring instance phrase, aᵢ^{l} represents softmax value of hₑᵢ^{l}, and represents the correlation with the first query vector, e(v^{l}) represents the true value of label of the first neighboring instance phrase, L represents the total number of labels.

3. The fine-tuning method for classification model of knowledge representation decoupling according to claim 1, wherein, the adjusted classification loss L is expressed as:
$$L = ( 1 + β F ( {p}_{knn} ) ) {L}_{CE}$$
wherein, L_{CE} represents the classification loss, β represents an adjustment parameter, F(pₖₙₙ) represents the weight factor, which is expressed as F(pₖₙₙ)=−log(pₖₙₙ), pₖₙₙ represents the true value of label of the masked words.

4. The fine-tuning method for classification model of knowledge representation decoupling according to claim 1, wherein, comprising: calculating the classification loss based on the cross entropy of the classification and prediction probability and the true value of label of masked words.

5. The fine-tuning method for classification model of knowledge representation decoupling according to claim 1, comprising: a first embedded vector extracted from the pre-trained language model and its corresponding true value of label form a new instance phrase, which is asynchronously updated to the knowledge base.

6. The fine-tuning device for classification model of knowledge representation decoupling according to claim 1, wherein, comprising:
a knowledge base construction and update unit, building a knowledge base for retrieval, where multiple instance phrases are stored in the form of key value pair, the key stores an embedding vector of the instance phrase, and the value stores a true value of label of the instance phrase;
a classification model construction unit, constructing a classification model that comprises a pre-trained language model and a prediction and classification module;
a query and aggregation unit, using the pre-trained language model to extract a first embedding vector of the masked words in the input instance text, and using this first embedding vector as a first query vector, for each label class, querying multiple instance phrases closest to the first query vector from the knowledge base as a first neighboring instance phrase, using an aggregation result obtained by aggregating all the first neighboring instance phrases with the first query vector as an input data for the pre-trained language model;
a loss calculation unit, using the pre-trained language model to extract a second embedding vector of the masked words in the input data, and using the prediction and classification module to classify and predict the second embedding vector to obtain a classification and prediction probability, based on the classification and prediction probability and the true value of label of the masked words, calculating a classification loss;
a loss adjustment unit, constructing a weight factor based on the true value of label of the masking word, and adjusting the classification loss based on the weight factor to make the classification loss more focused on misclassified instances;
a parameter optimization, optimizing parameters of the classification model by using the adjusted classification loss to obtain a classification model after parameters optimization.

7. A task classification method by using classification model of knowledge representation decoupling, wherein, the task classification method applies the knowledge base constructed by the fine-tuning method according to claim 1, and the classification model after parameters optimization, comprising the following steps:
step 1: using the classification model after parameters optimization to extract a third embedding vector of the masked words in the input instance text, and using the third embedding vector as a third query vector, for each label class, querying multiple instance phrases closest to the third query vector from the knowledge base as a third neighboring instance phrase, using an aggregation result obtained by aggregating all the third neighboring instance phrases with the third query vector as an input data for the pre-trained language model;
step 2, using the pre-trained language model after parameters optimization to extract a fourth embedding vector of masking words from the input data, for each class, querying multiple instance texts closest to the fourth query vector from the knowledge base as a fourth neighboring instance text, calculating a class correlation probability based on the similarity between the fourth query vector and the fourth neighboring instance text;
step 3, using the prediction and classification module after parameters optimization to classify and predict the fourth embedded vector to obtain a classification and prediction probability; and
step 4, using a weighted result of the class correlation probability and the classification and prediction probability of each class as the total classification and prediction result.

8. The task classification method by using classification model of knowledge representation decoupling according to claim 7, wherein, the class correlation probability is calculated based on the similarity between the fourth query vector and the fourth neighboring instance text by using the following formula:
$${P}_{KNN} ( {y}_{i} \vert {q}_{t} ) = {\sum }_{( ci , yi ) ∈ N} exp ( d ( {h}_{{q}_{t}} , {h}_{ci} ) )$$
wherein, P_{KNN}(yi|qₜ) represents the class correlation probability of the i-th classification class of the input instance text qₜ, d(h_{q}_{ₜ}, h_{ci}) represents an inner product distance between the fourth query vector h_{q}_{ₜ} of the input instance text qₜ and the embedding vector h_{ci} of instance phrase ci belonging to the i-th classification category yi, which is taken as an inner product similarity, N represents the knowledge base.

9. The task classification method by using classification model of knowledge representation decoupling according to claim 7, wherein, when used for relationship classification tasks, the true value of the label of instance phrases stored in the knowledge base is the relationship type, comprising friend relationship, kinship relationship, colleague relationship, and classmate relationship, during relationship classification, the class correlation probability of each relationship type is calculated through steps 1 and 2 based on the input instance text, the classification and prediction probability is calculated according to step 3, and the total classification and prediction result corresponding to each relationship type is calculated according to step 4, the maximum total classification and prediction result obtained through filtering is used as the final relationship classification result corresponding to the input instance text.

10. The task classification method by using classification model of knowledge representation decoupling according to claim 7, wherein, when used for emotion classification tasks, the true value of the label of instance phrases stored in the knowledge base are emotion types, comprising positive and negative emotions, when performing emotion classification, the class correlation probability of each emotion type is calculated through steps 1 and 2 based on the input instance text, the classification and prediction probability is calculated according to step 3, and the total classification and prediction result corresponding to the emotion type is calculated according to step 4, the maximum total classification and prediction result obtained through filtering is used as the final emotion classification result corresponding to the input instance text.
